(19) United States
(12) Patent Application Publication
(10) Pub. No.: US 2016/0004502 A1
(43) Pub. Date: Jan. 7, 2016

(54) SYSTEM AND METHOD FOR CORRECTING SPEECH INPUT

(71) Applicant: CloudCar, Inc., Mountain View, CA (US)

(72) Inventors: Dominic Winkelman, San Mateo, CA (US); Daniel Eide, Mountain View, CA (US); Konstantin Othmer, Los Altos, CA (US)

(21) Appl. No.: 14/855,295

(22) Filed: Sep. 15, 2015

Related U.S. Application Data
(63) Continuation-in-part of application No. 13/943,730, filed on Jul. 16, 2013.
(60) Provisional application No. 62/115,400, filed on Feb. 12, 2015.
(60) Provisional application No. 62/115,406, filed on Feb. 12, 2015.

(51) Int. Cl. G06F 3/16; G10L 15/187; G10L 15/22

(52) U.S. Cl. CPC G06F 3/167; G10L 15/22; G10L 15/187; G10L 2015/223

(57) ABSTRACT

A system and method for correcting speech input are disclosed. A particular embodiment includes: receiving a base input string; detecting a correction operation; receiving a replacement string in response to the correction operation; generating a base object set from the base input string and a replacement object set from the replacement string; identifying a matching base object of the base object set that is most phonetically similar to a replacement object of the replacement object set; and replacing the matching base object with the replacement object in the base input string.

### PRIORITY PATENT APPLICATIONS

This is a continuation-in-part patent application of co-pending U.S. patent application Ser. No. 13/943,730; filed Jul. 16, 2013 by the same applicant. This is also a non-provisional patent application drawing prior from co-pending U.S. provisional patent applications, Ser. Nos. 62/115,400 and 62/115,406; both filed Feb. 12, 2015 by the same applicant. This present patent application draws priority from the referenced patent applications. The entire disclosure of the referenced patent applications is considered part of the disclosure of the present application and is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever. The following notice applies to the disclosure herein and to the drawings that form a part of this document: Copyright 2012-2015, CloudCar Inc., All Rights Reserved.

### TECHNICAL FIELD

This patent document pertains generally to tools (systems, apparatuses, methodologies, computer program products, etc.) for allowing electronic devices to share information with each other, and more particularly, but not by way of limitation, to a system and method for correcting speech input.

### BACKGROUND

Modern speech recognition applications can utilize a computer to convert acoustic signals received by a microphone into a workable set of data without the benefit of a QWERTY keyboard. Subsequently, the set of data can be used in a wide variety of other computer programs, including document preparation, data entry, command and control, messaging, and other program applications as well. Thus, speech recognition is a technology well-suited for use in devices not having the benefit of keyboard input and monitor feedback.

Still, effective speech recognition can be a difficult problem, even in traditional computing, because of a wide variety of pronunciations, individual accents, and the various speech characteristics of multiple speakers. Ambient noise also frequently complicates the speech recognition process, as the computer may try to recognize and interpret the background noise as speech. Hence, speech recognition systems can often mis-recognize speech input compelling the speaker to perform a correction of the mis-recognized speech.

Typically, in traditional computers, for example a desktop Personal Computer (PC), the correction of mis-recognized speech can be performed with the assistance of both a visual display and a keyboard. However, correction of mis-recognized speech in a device having limited or no display can prove complicated if not unworkable. Consequently, a need exists for a correction method for speech recognition applications operating in devices having limited or no display. Such a system could have particular utility in the context of a speech recognition system used to dictate e-mail, telephonic text, and other messages on devices having only a limited or no display channel.

Many conventional speech recognition systems engage the user in various verbal exchanges to decipher the intended meaning of a spoken phrase, if the speech recognition system is initially unable to correctly recognize the speech. In most cases, conventional systems require that a user utter a separate audible command for correcting the recognized speech. However, these verbal exchanges and audible commands between the user and the speech recognition system can be annoying or even unsafe if, for example, the speech recognition system is being used in a moving vehicle.

### BRIEF DESCRIPTION OF THE DRAWINGS

The various embodiments are illustrated by way of example, and not by way of limitation, in the figures of the accompanying drawings in which:

FIG. 1 illustrates a block diagram of an example ecosystem in which an in-vehicle speech input processing module of an example embodiment can be implemented;

FIG. 2 illustrates the components of the in-vehicle speech input processing module of an example embodiment;

FIG. 3 is a process flow diagram illustrating an example embodiment of a system and method for correcting speech input;

FIG. 4 illustrates an example of a base input string in an example embodiment;

FIG. 5 illustrates the example of the base input string in the example embodiment partitioned into discrete objects with corresponding phonetic representations;

FIG. 6 illustrates an example of a replacement string in an example embodiment;

FIG. 7 illustrates the example of the replacement string in the example embodiment partitioned into discrete objects with corresponding phonetic representations;

FIGS. 8 and 9 illustrate an example of scoring the differences between the base object set and the replacement object set with corresponding phonetic representations;

FIG. 10 illustrates an example of the replacement object set being substituted into the updated base object set in the example embodiment with corresponding phonetic representations;

FIG. 11 illustrates the example of the updated base object set in the example embodiment with corresponding phonetic representations;

FIG. 12 illustrates an example of updated base input string in the example embodiment;

FIG. 13 illustrates example embodiments in which the processing of various embodiments is implemented by applications (apps) executing on any of a variety of platforms;

FIG. 14 is a process flow diagram illustrating an example embodiment of a system and method for correcting speech input;

FIG. 15 is a process flow diagram illustrating an alternative example embodiment of a system and method for correcting speech input; and

FIG. 16 shows a diagrammatic representation of machine in the example form of a computer system within which a set of instructions when executed may cause the machine to perform any one or more of the methodologies discussed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

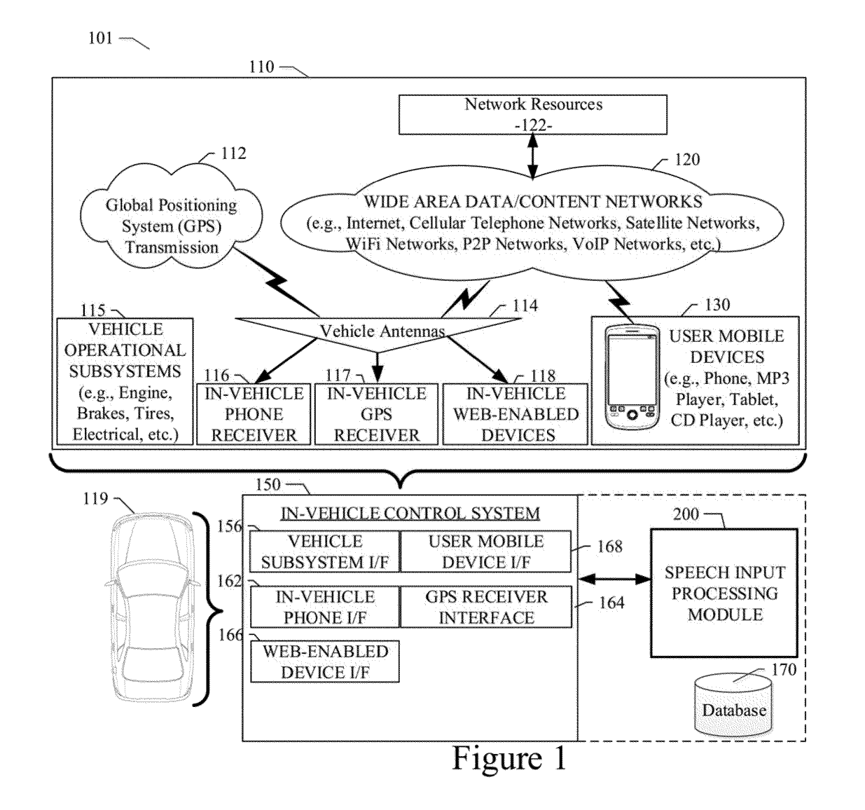

As described in various example embodiments, a system and method for correcting speech input are described herein. An example embodiment disclosed herein can be used in the context of an in-vehicle control system. In one example embodiment, an in-vehicle control system with a speech input processing module resident in a vehicle can be configured like the architecture illustrated in FIG. 1. However, it will be apparent to those of ordinary skill in the art that the speech input processing module described and claimed herein can be implemented, configured, and used in a variety of other applications and systems as well.

In an example embodiment as described herein, a mobile device with a mobile device application (app) in combination with a network cloud service can be used to implement the speech input correction process as described. Alternatively, the mobile device and the mobile app can operate as a stand-alone device for implementing speech input correction as described. In the example embodiment, a standard sound or voice input receiver (e.g., a microphone) or other components in the mobile device can be used to receive speech input from a user or an occupant in a vehicle. The cloud service and/or the mobile device app can be used in the various ways described herein to process the correction of the speech input. In a second example embodiment, an in-vehicle control system with a vehicle platform app resident in a user's vehicle in combination with the cloud service can be used to implement the speech input correction process as described herein. Alternatively, the in-vehicle control system and the vehicle platform app can operate as a stand-alone device for implementing speech input correction as described. In the second example embodiment, a standard sound or voice input receiver (e.g., a microphone) or other components in the in-vehicle control system can be used to receive speech input from a user or an occupant in the vehicle. The cloud service and/or the vehicle platform app can be used in the various ways described herein to process the correction of the speech input. In other embodiments, the system and method for correcting speech input as described herein can be used in mobile or stationary computing or communication platforms that are not part of vehicle subsystem.

Referring now to FIG. 1, a block diagram illustrates an example ecosystem 101 in which an in-vehicle control system 150 and a speech input processing module 200 of an example embodiment can be implemented. These components are described in more detail below. Ecosystem 101 includes a variety of systems and components that can generate and/or deliver one or more sources of information/data and related services to the in-vehicle control system 150 and the speech input processing module 200, which can be installed in a vehicle 119. For example, a standard Global Positioning System (GPS) network 112 can generate geo-location data and timing data or other navigation information that can be received by an in-vehicle GPS receiver 117 via vehicle antenna 114. The in-vehicle control system 150 and the speech input processing module 200 can receive this geo-location data, timing data, and navigation information via the GPS receiver interface 164, which can be used to connect the in-vehicle control system 150 with the in-vehicle GPS receiver 117 to obtain the geo-location data, timing data, and navigation information.

Similarly, ecosystem 101 can include a wide area data/content network 120. The network 120 represents one or more conventional wide area data/content networks, such as the Internet, a cellular telephone network, satellite network, pager network, a wireless broadcast network, gaming network, WiFi network, peer-to-peer network, Voice over IP (VoIP) network, etc. One or more of these networks 120 can be used to connect a user or client system with network resources 122, such as websites, servers, call distribution sites, headend content delivery sites, or the like. The network resources 122 can generate and/or distribute data, which can be received in vehicle 119 via one or more antennas 114. The network resources 122 can also host network cloud services, which can support the functionality used to compute or assist in processing speech input or speech input corrections. Antennas 114 can serve to connect the in-vehicle control system 150 and the speech input processing module 200 with the data/content network 120 via cellular, satellite, radio, or other conventional signal reception mechanisms. Such cellular data or content networks are currently available (e.g., Verizon™, AT&T™, T-Mobile™, etc.). Such satellite-based data or content networks are also currently available (e.g., SiriusXM™, HughesNet™, etc.). The conventional broadcast networks, such as AM/FM radio networks, pager networks, UHF networks, gaming networks, WiFi networks, peer-to-peer networks, Voice over IP (VoIP) networks, and the like are also well-known. Thus, as described in more detail below, the in-vehicle control system 150 and the speech input processing module 200 can receive telephone calls and/or phone-based data transmissions via an in-vehicle phone interface 162, which can be used to connect with the in-vehicle phone receiver 116 and network 120. The in-vehicle control system 150 and the speech input processing module 200 can also receive web-based data or content via an in-vehicle web-enabled device interface 166, which can be used to connect with the in-vehicle web-enabled device receiver 118 and network 120. In this manner, the in-vehicle control system 150 and the speech input processing module 200 can support a variety of network-connectable in-vehicle devices and systems from within a vehicle 119.

As shown in FIG. 1, the in-vehicle control system 150 and the speech input processing module 200 can also receive data, speech input, and content from user mobile devices 130, which are located inside or proximately to the vehicle 119. The user mobile devices 130 can represent standard mobile devices, such as cellular phones, smartphones, personal digital assistants (PDA's), MP3 players, tablet computing devices (e.g., iPad™), laptop computers, CD players, and other mobile devices, which can produce, receive, and/or deliver data, speech input, and content for the in-vehicle control system 150 and the speech input processing module 200. As shown in FIG. 1, the mobile devices 130 can also be in data communication with the network cloud 120. The mobile devices 130 can source data and content from internal memory components of the mobile devices 130 themselves or from network resources 122 via network 120. Additionally, mobile devices 130 can themselves include a GPS data receiver, accelerometers, WiFi triangulation, or other geo-location sensors or components in the mobile device, which can be used to determine the real-time geo-location of the user (via the mobile device) at any moment in time. In each case, the in-vehicle control system 150 and the speech input processing module 200 can receive this data, speech input, and/or content from the mobile devices 130 as shown in FIG. 1.

In various embodiments, the mobile device 130 interface and user interface between the in-vehicle control system 150 and the mobile devices 130 can be implemented in a variety of ways. For example, in one embodiment, the mobile device 130 interface between the in-vehicle control system 150 and the mobile devices 130 can be implemented using a Universal Serial Bus (USB) interface and associated connector. In another embodiment, the interface between the in-vehicle control system 150 and the mobile devices 130 can be implemented using a wireless protocol, such as WiFi or Bluetooth™ (BT). WiFi is a popular wireless technology allowing an electronic device to exchange data wirelessly over a computer network. Bluetooth™ is a well-known wireless technology standard for exchanging data over short distances. Using standard mobile device 130 interfaces, a mobile device 130 can be paired and/or synchronized with the in-vehicle control system 150 when the mobile device 130 is moved within a proximity region of the in-vehicle control system 150. The user mobile device interface 168 can be used to facilitate this pairing. Once the in-vehicle control system 150 is paired with the mobile device 130, the mobile device 130 can share information with the in-vehicle control system 150 and the speech input processing module 200 in data communication therewith.

Referring again to FIG. 1 in an example embodiment as described above, the in-vehicle control system 150 and the speech input processing module 200 can receive speech input, verbal utterances, audible data, audible commands, and/or other types of data, speech input, and content from a variety of sources in ecosystem 101, both local (e.g., within proximity of the in-vehicle control system 150) and remote (e.g., accessible via data network 120). These sources can include wireless broadcasts, data, speech input, and content from proximate user mobile devices 130 (e.g., a mobile device proximately located in or near the vehicle 119), data, speech input, and content from network 120 cloud-based resources 122, an in-vehicle phone receiver 116, an in-vehicle GPS receiver or navigation system 117, in-vehicle web-enabled devices 118, or other in-vehicle devices that produce, consume, or distribute data, speech input, and/or content.

Referring still to FIG. 1, the example embodiment of ecosystem 101 can include vehicle operational subsystems 115. For embodiments that are implemented in a vehicle 119, many standard vehicles include operational subsystems, such as electronic control units (ECUs), supporting monitoring/control subsystems for the engine, brakes, transmission, electrical system, emissions system, interior environment, and the like. For example, data signals communicated from the vehicle operational subsystems 115 (e.g., ECUs of the vehicle 119) to the in-vehicle control system 150 via vehicle subsystem interface 156 may include information about the state of one or more of the components or subsystems of the vehicle 119. In particular, the data signals, which can be communicated from the vehicle operational subsystems 115 to a Controller Area Network (CAN) bus of the vehicle 119, can be received and processed by the in-vehicle control system 150 via vehicle subsystem interface 156. Embodiments of the systems and methods described herein can be used with substantially any mechanized system that uses a CAN bus or similar data communications bus as defined herein, including, but not limited to, industrial equipment, boats, trucks, machinery, or automobiles; thus, the term “vehicle” as used herein can include any such mechanized systems. Embodiments of the systems and methods described herein can also be used with any systems employing some form of network data communications; however, such network communications are not required.

In the example embodiment shown in FIG. 1, the in-vehicle control system 150 can also include a rendering system to enable a user to view and/or hear information, synthesized speech, spoken audio, content, and control prompts provided by the in-vehicle control system 150. The rendering system can include standard visual display devices (e.g., plasma displays, liquid crystal displays (LCDs), touchscreen displays, heads-up displays, or the like) and speakers or other audio output devices.

Additionally, other data and/or content (denoted herein as ancillary data) can be obtained from local and/or remote sources by the in-vehicle control system 150 as described above. The ancillary data can be used to augment or modify the operation of the speech input processing module 200 based on a variety of factors including, user context (e.g., the identity, age, profile, and driving history of the user), the context in which the user is operating the vehicle (e.g., the location of the vehicle, the specified destination, direction of travel, speed, the time of day, the status of the vehicle, etc.), and a variety of other data obtainable from the variety of sources, local and remote, as described herein.

In a particular embodiment, the in-vehicle control system 150 and the speech input processing module 200 can be implemented as in-vehicle components of vehicle 119. In various example embodiments, the in-vehicle control system 150 and the speech input processing module 200 in data communication therewith can be implemented as integrated components or as separate components. In an example embodiment, the software components of the in-vehicle control system 150 and/or the speech input processing module 200 can be dynamically upgraded, modified, and/or augmented by use of the data connection with the mobile devices 130 and/or the network resources 122 via network 120. The in-vehicle control system 150 can periodically query a mobile device 130 or a network resource 122 for updates or updates can be pushed to the in-vehicle control system 150.

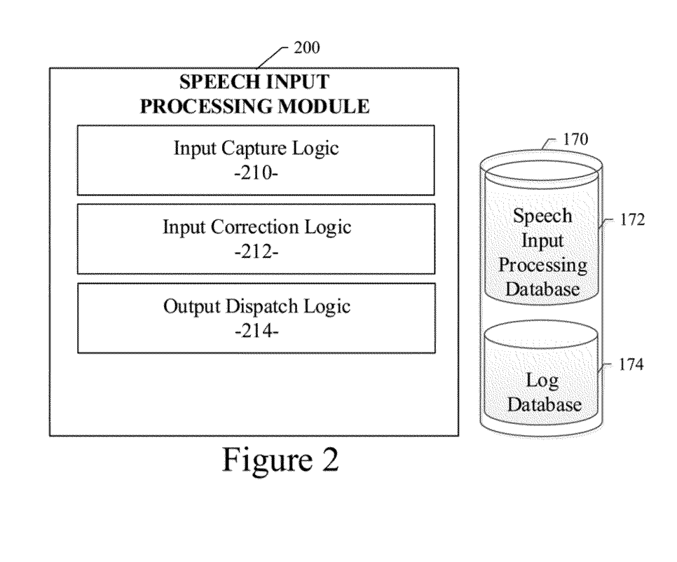

Referring now to FIG. 2, a diagram illustrates the components of the speech input processing module 200 of an example embodiment. In the example embodiment, the speech input processing module 200 can be configured to include an interface with the in-vehicle control system 150, as shown in FIG. 1, through which the speech input processing module 200 can send and receive data as described herein. Additionally, the speech input processing module 200 can be configured to include an interface with the in-vehicle control system 150 and/or other ecosystem 101 subsystems through which the speech input processing module 200 can receive ancillary data from the various data and content sources as described above. As described above, the speech input processing module 200 can also be implemented in systems and platforms that are not deployed in a vehicle and not necessarily used in or with a vehicle.

### Speech Input Processing in an Example Embodiment

In an example embodiment as shown in FIG. 2, the speech input processing module 200 can be configured to include an input capture logic module 210, input correction logic module 212, and an output dispatch logic module 214. Each of these modules can be implemented as software, firmware, or other logic components executing or activated within an executable environment of the speech input processing module 200 operating within or in data communication with the in-vehicle control system 150. Each of these modules of an example embodiment is described in more detail below in connection with the figures provided herein.

The input capture logic module 210 of an example embodiment is responsible for obtaining or receiving a spoken base input string. The spoken base input string can be any type of spoken or audible words, phrases, or utterances intended by a user as an informational or instructional verbal communication to one or more of the electronic devices or systems as described above. For example, a user/driver may speak a verbal command or utterance to a vehicle navigation system. In another example, a user may speak a verbal command or utterance to a mobile phone or other mobile device. In yet another example, a user may speak a verbal command or utterance to a vehicle subsystem, such as the vehicle navigation subsystem or cruise control subsystem. It will be apparent to those of ordinary skill in the art that a user, driver, or vehicle occupant may utter statements, commands, or other types of speech input in a variety of contexts, which target a variety of ecosystem devices or subsystems. As described above, the speech input processing module 200 and the input capture logic module 210 therein can receive these speech input utterances from a variety of sources.

The speech input received by the input capture logic module 210 can be structured as a sequence or collection of words, phrases, or discrete utterances (generally denoted objects). As well-known in the art, each utterance (object) can have a corresponding phonetic representation, which associates a particular sound with a corresponding written, textual, symbolic, or visual representation. The collection of objects for each speech input can be denoted herein as a spoken input string. Each spoken input string is comprised of an object set, which represents the utterances that combine to form the spoken input string. It will be apparent to those of ordinary skill in the art in view of the disclosure herein that the spoken input string can be in any arbitrary spoken language or dialect. The input capture logic module 210 of the example embodiment can obtain or receive a spoken input string as an initial speech input for a speech transaction that may include a plurality of spoken input strings for the same speech transaction. An example of a speech transaction might be a user speaking a series of voice commands to a vehicle navigation subsystem or a mobile device app. This aspect of the example embodiment is described in more detail below. As denoted herein, the first speech input from a user for a particular speech transaction can be referred to as the spoken base input string. Subsequent speech input from the user for the same speech transaction can be denoted as the spoken secondary input string or the spoken replacement string. As described in detail below, the input correction logic module 212 of the example embodiment can receive the speech input from the input capture logic module 210 and modify the spoken base input string in a manner that corresponds to the speech input received from the user as the spoken secondary input string or the spoken replacement string.

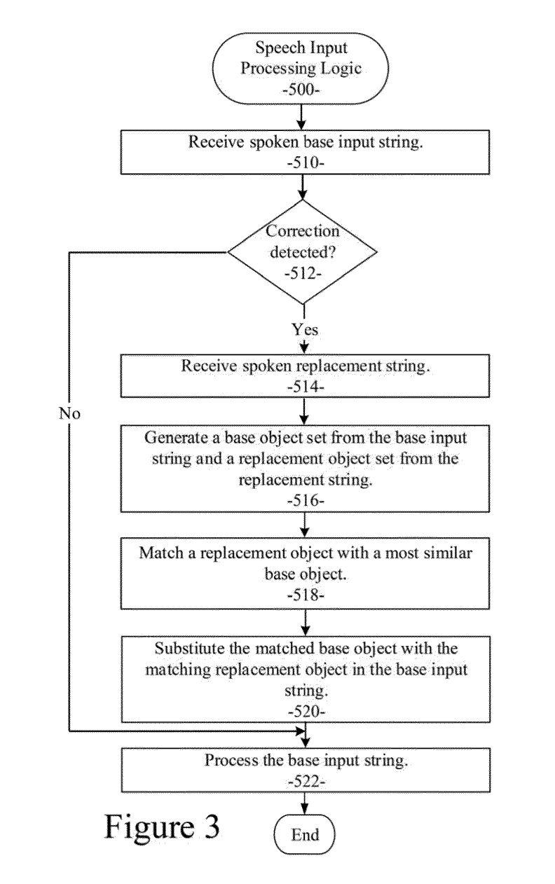

Referring now to FIG. 3, a process flow diagram illustrates an example embodiment of a system and method 500 for correcting speech input. In particular, FIG. 3 illustrates the processing performed by the input correction logic module 212 of the example embodiment. As described above, the input correction logic module 212 can receive a spoken base input string from the input capture logic module 210. In an alternative embodiment, the base input string can be provided via a keyboard entry, a mouse click, or other non-spoken forms of data entry. The received spoken base input string represents a first or initial speech input from a user for a particular speech transaction. The spoken base input string can include a plurality of objects in an object set from which the spoken base input string is comprised.

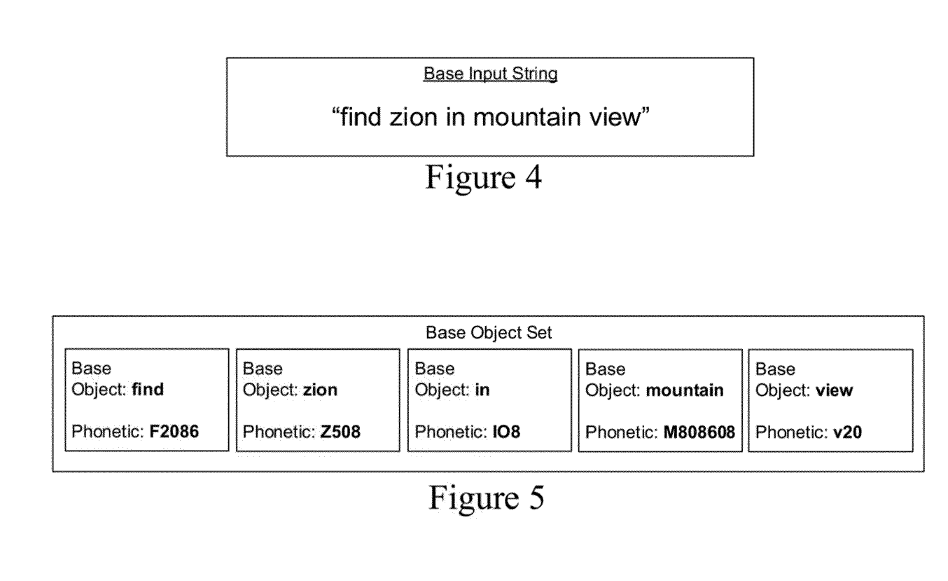

FIG. 4 illustrates an example of a base input string in an example embodiment. FIG. 5 illustrates the example of the base input string of FIG. 4 partitioned into discrete objects (the base object set) with corresponding phonetic representations. In the hypothetical example of FIGS. 4 and 5, a user in a vehicle has issued a spoken command to, for example, a vehicle navigation system. In this example, the spoken command in the form of a base input string is as follows:
“find zion in mountain view”

A conventional automatic speech recognition subsystem can be used to convert the audible utterances into a written, textual, symbolic, or visual representation, such as the text string shown above and in FIG. 4. It will be apparent to those of ordinary skill in the art in view of the disclosure herein that the base input string can be any arbitrary utterance in a variety of different applications and contexts.

The sample base input string shown in FIG. 4 is comprised of a plurality or set of base objects. The corresponding base object set for the base input string of the example of FIG. 4 is shown in FIG. 5. In this example, the base object set represents each individual word spoken as part of the base input string. In an alternative embodiment, the objects in the base object set can represent other partitions of the base input string. For example, in an alternative embodiment, the objects in the base object set can represent individual phonemes, morphemes, syllables, word phrases, or other primitives of the base input string.

Each object of the base object set can have a corresponding phonetic representation. In this example embodiment, the well-known “Refined Soundex” algorithm is used to calculate the phonetic representations of each object. The Refined Soundex algorithm originates from the conventional Apache Commons Codec Language package. The Refined Soundex algorithm is based off of the original Soundex algorithm developed by Margaret Odell and Robert Russell (U.S. Pat. Nos. 1,261,167 and 1,435,663). However, it will be apparent to those of ordinary skill in the art in view of the disclosure herein that another algorithm or process can be used to generate the phonetic representation of the objects in the base input string.

In the example embodiment, the phonetic representations of each of the objects in the base input string are alphanumeric codings that represent the particular sounds or audible signature of the corresponding object. FIG. 5 illustrates the particular phonetic representations that correspond to the example base input string of FIG. 4. It will be apparent to those of ordinary skill in the art in view of the disclosure herein that another form of coding can be used for the phonetic representations of the objects in the base input string. In the example embodiment, the alphanumeric codings for the phonetic representations of the objects in the base input string provide a convenient way for comparing and matching the phonetic similarity of objects in the base input string.

Referring again to FIG. 3, the example embodiment of the method 500 for correcting speech input includes determining if a correction of the received spoken base input string is required (decision block 512). In many circumstances, conventional automatic speech recognition subsystems can produce errors, because of a wide variety of pronunciations, individual accents, and the various speech characteristics of multiple speakers. Ambient noise also frequently complicates the speech recognition process, as the system may try to recognize and interpret the background noise as speech. As a result, speech recognition subsystems can often mis-recognize speech input compelling the speaker to perform a correction of the mis-recognized speech. Such corrections can be initiated by the speaker in a variety of ways. For example, in a desktop PC system or other computing platform with a display and keyboard, the correction of mis-recognized speech can be performed with the assistance of both the visual display and the keyboard. However, correction of mis-recognized speech in a device or on a computing platform having limited or no display can prove complicated if not unworkable. The various embodiments described herein provide a speech correction method for speech recognition applications operating in devices having limited or no display. The various embodiments provide a speech correction technique that does not need a display device or keyboard.

Many conventional speech recognition systems engage the user in various verbal exchanges to decipher the intended meaning of a spoken phrase, if the speech recognition system is initially unable to correctly recognize the speech. In most cases, conventional systems require that a user utter a separate audible command for correcting the recognized speech. However, these verbal exchanges and audible commands between the user and the speech recognition system can be annoying or even unsafe if, for example, the speech recognition system is being used in a moving vehicle.

The various embodiments described herein enable the user/speaker to initiate a speech correction operation in any of the traditional ways. For example, if the user/speaker uttered a spoken base string that was not recognized correctly by the automatic voice recognition system, the user/speaker can explicitly initiate a speech correction operation by performing any of the following actions: clicking an icon, activating a softkey, pressing a physical button, providing a keyboard input, manipulating a user interface, or uttering a separate audible command for correcting the recognized speech captured as the spoken base input string. In addition, the example embodiments described herein provide an implicit technique for initiating a speech correction operation. In the example embodiment, the implicit speech correction operation is initiated when the user/speaker begins to spell out a word or phrase or the speech recognition subsystem recognizes the spoken utterance of one or more letters. When the user/speaker uses any of these explicit or implicit techniques for initiating a speech correction operation, the input correction logic module 212 can detect the initiation of the speech correction operation. Referring again to FIG. 3 at decision block 512, if on receipt of the spoken base input string, the input correction logic module 212 does not detect the initiation of any speech correction operation as described above, processing continues at processing block 522 where the received spoken base input string is processed as received. However, if on receipt of the spoken base input string, the input correction logic module 212 detects the initiation of an explicit or implicit speech correction operation as described above, processing continues at processing block 514 where the input correction logic module 212 is configured to receive a spoken replacement or secondary string. The spoken replacement or secondary string is used by the example embodiment to modify the spoken base input string as described below.

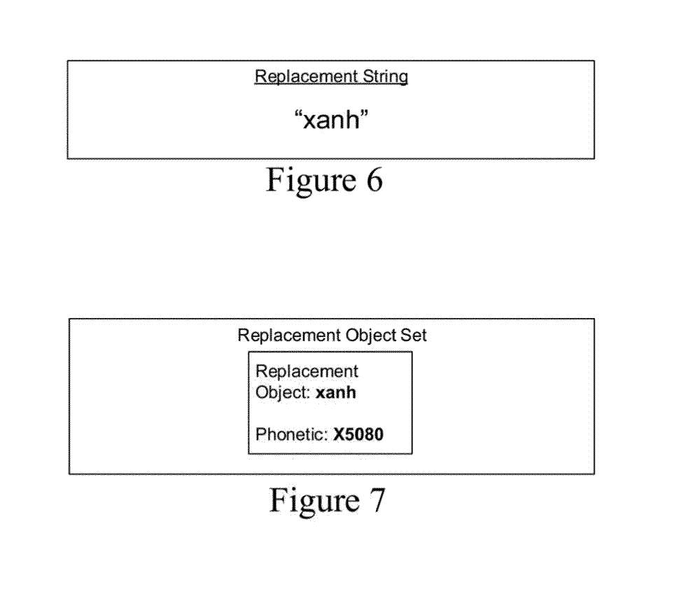

FIG. 6 illustrates an example of a replacement string in an example embodiment. FIG. 7 illustrates the example of the replacement string of FIG. 6 partitioned into discrete objects (denoted the replacement object set) with corresponding phonetic representations. Referring now to FIG. 6 in the example embodiment, the user/speaker has initiated an implicit speech correction operation by verbally spelling out the following letters in spoken utterances:
“X” “A” “N” “H”

### Or

“XANH”

As described above, the user can alternatively spell out the letters of a replacement string using a keyboard, keypad, or other data input device. In this example, the user intends the replacement string of FIG. 6 to be substituted into the base input string of FIG. 4 at the appropriate location. However, in the example embodiment, the user is not required to specify which portion of the base input string is to be replaced. Instead, the input correction logic module 212 is configured to automatically identify the best match for the replacement string in the original base input string. As described in more detail below, the example embodiment can identify the best match and effect the string substitution without further input from the user/speaker. As a result, the user can make corrections to the base input string with minimal interaction with the speech input processing module 200 and no interaction with a display device or keyboard. This enables the user to make corrections with very little effort or distraction. Thus, the example embodiments are particularly useful in applications, such as vehicle systems where user distraction is an important issue.

Referring now to FIG. 7 for an example embodiment, the phonetic representations of each of the objects in the replacement string are converted to alphanumeric codings that represent the particular sounds or audible signature of the corresponding object as described above. FIG. 7 illustrates the particular phonetic representations that correspond to the example replacement string of FIG. 6. It will be apparent to those of ordinary skill in the art in view of the disclosure herein that another form of coding can be used for the phonetic representations of the objects in the replacement string.

Referring again to FIG. 3, the example embodiment of the method 500 for correcting speech input includes receiving a spoken replacement string (processing block 514) and generating a base object set from the base object string and a replacement object set from the replacement string (processing block 516). As described above with regard to FIGS. 4 and 5, the example embodiment can generate a base object set from the base input string. The base object set can include the particular phonetic representations that correspond to each of the objects in the example base object set. Similarly, as described above with regard to FIGS. 6 and 7, the example embodiment can generate a replacement object set from the replacement string. The replacement object set can include the particular phonetic representations that correspond to each of the objects in the example replacement object set.

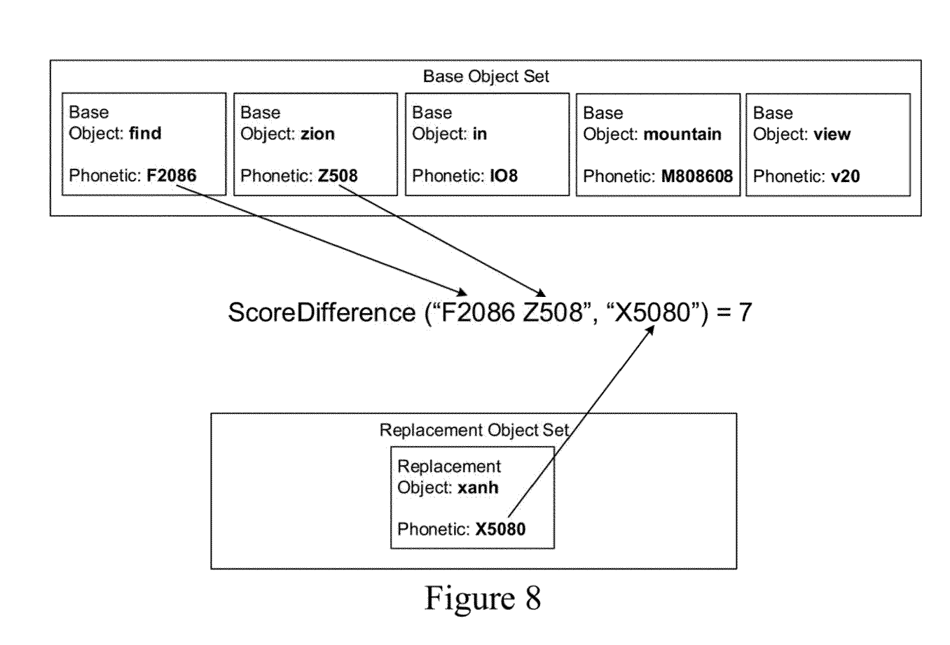

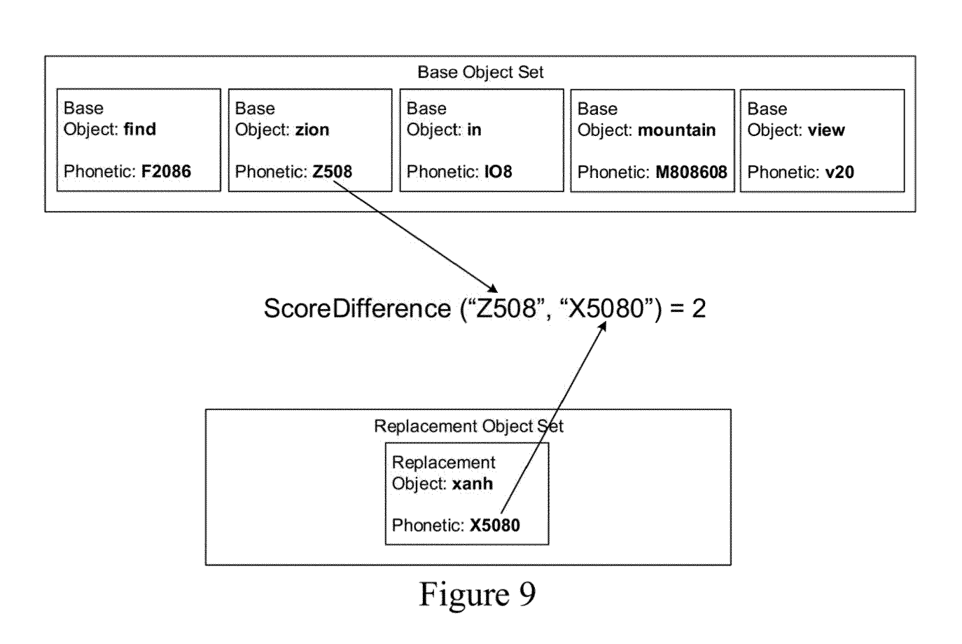

Referring now to FIGS. 8 and 9 for the example embodiment, the phonetic representations for each of the objects in the base object set can be compared to the phonetic representations for each of the objects in the replacement object set. FIGS. 8 and 9 illustrate an example of scoring the differences between each of the objects in the base object set and each of the objects in the replacement object set using the corresponding phonetic representations. In the example shown in FIG. 8, a scoring function (denoted in this example as ScoreDifference) can receive as input the phonetic representations for one or more objects of the base object set and one or more objects of the replacement object set. The scoring function can determine a difference score for each pair of objects from the base object set and the replacement set. For example, as shown in FIG. 8, the scoring function has compared the base object “find” having a phonetic representation of “F2086” with the replacement object “xanh” having a phonetic representation of “X5080”. As a result, the scoring function has produced a score of “7” corresponding to the level of phonetic differences between this pair of objects. As shown in FIG. 9, the scoring function has compared the base object “zion” having a phonetic representation of “Z508” with the replacement object “xanh” having a phonetic representation of “X5080”. As a result, the scoring function has produced a score of “2” corresponding to the level of phonetic differences between this pair of objects. In this example, the scoring function has determined that the level of phonetic differences between the base object “find” and the replacement object “xanh” (e.g., 7) is greater than the level of phonetic differences between the base object “zion” and the replacement object “xanh” (e.g., 2). In this case, the scoring function has determined that base object “zion” is more phonetically similar to the replacement object “xanh” than the base object “find” (e.g., 2<7). The example embodiment can use this phonetic scoring information to determine that the user/speaker is most likely intending to cause the most phonetically similar object of the base object set to be replaced with the object(s) in the replacement object set. Thus, the example embodiment can use the scoring function as described above to test the differences between the replacement objects and each of the base objects to identify a base object that is the most phonetically similar to a replacement object (e.g., the base object with the lowest score relative to a replacement object). This feature of the example embodiment is also shown in FIG. 3 at processing block 518 where a replacement object is matched with a most similar base object. As described in more detail below, this identified or matched most phonetically similar base object can be replaced in the base input string with the corresponding replacement object. In the example embodiment, a maximal difference score can be predefined to prevent replacement of the base object if the difference score is not less than the predefined level. In other words, the replacement object may not be used if the replacement object is not similar enough to any of the base objects. In this case, a message can be conveyed to the user/speaker to try the correction operation again. In other cases, two or more base objects may have exactly the same level of phonetic similarity to a replacement object. In this case, an embodiment can replace the first occurrence of the base object, replace the last occurrence of the base object, or convey a message to the user/speaker to try the correction operation again.

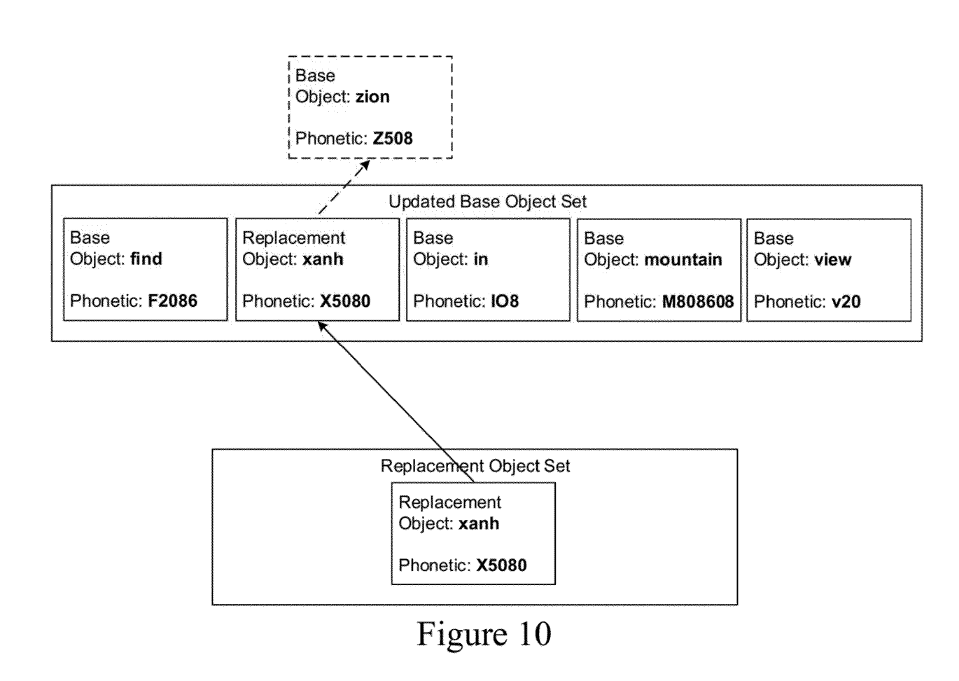

FIG. 10 illustrates an example of the replacement object set being substituted into the updated base object set in the example embodiment with corresponding phonetic representations. As described in the example above, the scoring function has identified a base object (e.g., “zion”) that is the most phonetically similar to a replacement object (e.g., “xanh”). In this case, the comparison of the base object (e.g., “zion”) with the replacement object (e.g., “xanh”) has resulted in the lowest difference score. In this example, the score is within the predefined maximal difference score. As shown in FIG. 10, the most phonetically similar base object (e.g., the matched base object) is replaced in the base object set with the replacement object. As shown in FIG. 3 at processing block 520, the matched base object is replaced with the matching replacement object in the base object set and the corresponding base input string.

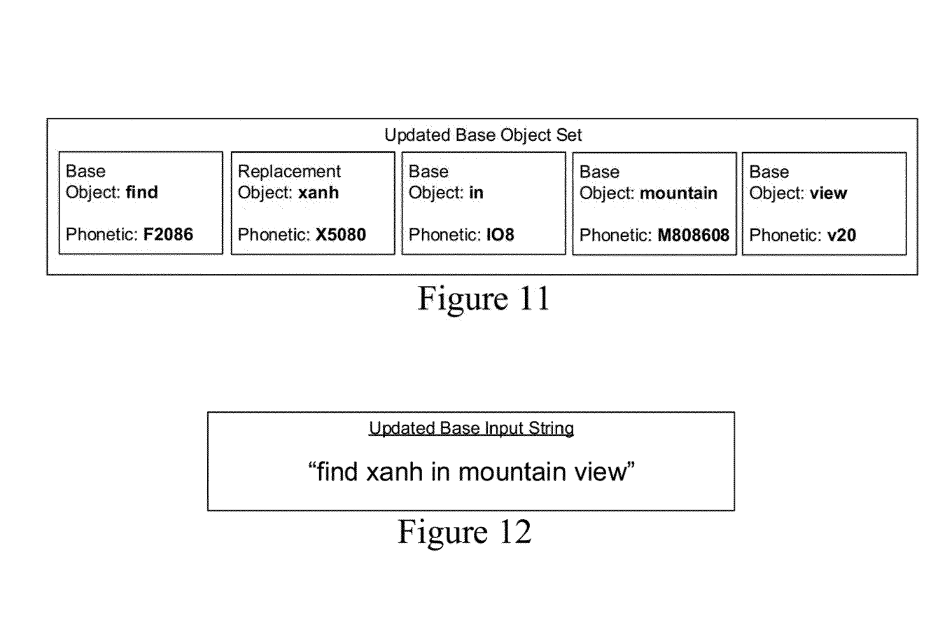

FIG. 11 illustrates the example of the updated base object set in the example embodiment with corresponding phonetic representations. In this example, the most phonetically similar replacement object (e.g., “xanh”) has been substituted into the updated base object set as described above. As a result, the base input string that corresponds to the updated base object set is also updated. FIG. 12 illustrates an example of the updated base input string in the example embodiment. It will be apparent to those of ordinary skill in the art in view of the disclosure herein that the systems and processes described herein can be used in a variety of applications, with a variety of platforms, and with a variety of base input strings.

Referring again to FIG. 2, the output dispatch logic module 214 of an example embodiment is responsible for dispatching the updated base input string to other system applications or to an output device for presentation to the user/speaker. As shown in FIG. 3 at processing block 522, the updated base input string can be further processed by the other applications or output devices. Thus, the description of the system and method for correcting speech input in an example embodiment is complete.

Referring again to FIG. 2, an example embodiment can record or log parameters associated with the speech input correction performed by the speech input processing module 200. For example, the described embodiments can record or log parameters associated with user accounts, user data, user preferences, user speech training data, user favorites, historical data, and a variety of other information associated with speech input correction. These log parameters can be stored in log database 174 of database 170 as shown in FIG. 2. For example, the log parameters can be used as a historical or training reference to retain information related to the manner in which a particular speech input transaction was previously processed for a particular user. This historical or training data can be used in the subsequent processing of a similar transaction with the same user or other users to facilitate faster and more efficient speech input correction processing.

In an alternative embodiment, the historical data can be used to provide the spoken base input string from a previously issued spoken command or utterance if a portion of the previous utterance matches a newly spoken replacement string. In this embodiment, the user/driver can merely utter a replacement string, such as the sample replacement string (e.g., “xanh”) as described above. In this example embodiment, the user/speaker can initiate the implicit speech correction operation by verbally spelling out letters of the replacement string. In the example described herein, the user/speaker can spell out the following letters in spoken utterances:
“X” “A” “N” “H”

### Or

“XANH”

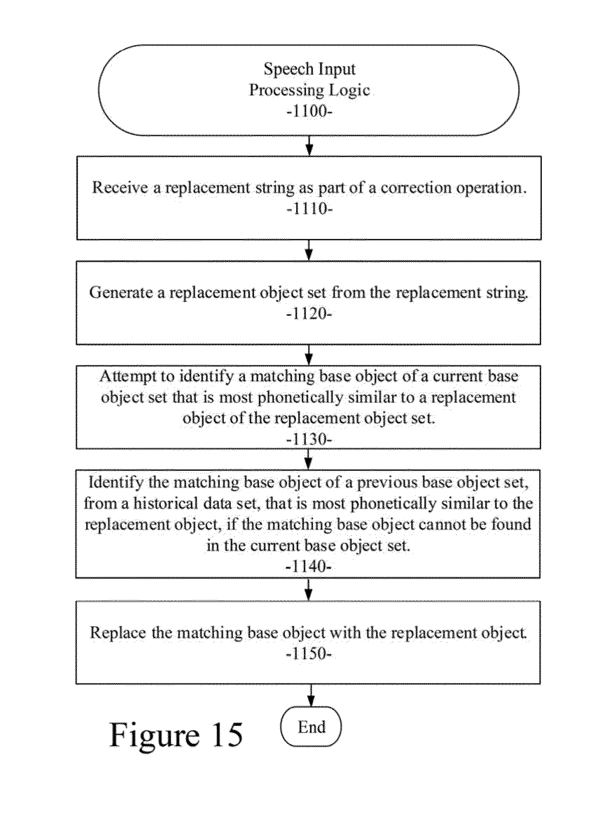

As described above, the user can alternatively spell out the letters of a replacement string using a keyboard, keypad, or other data input device. In this example, the user intends the replacement string of the example shown above to be substituted into a previously spoken base input string that has been captured in the historical data set of log database 174. In this case, the user/speaker is not required to repeat the previously spoken base input string. The user is also not required to specify which portion of the previously spoken base input string is to be replaced. Instead, the input correction logic module 212 is configured to automatically find a previously spoken base input string from a historical data set, wherein the previously spoken base input string includes a portion that matches the replacement string. Additionally, the input correction logic module 212 is configured to automatically identify the best match for the replacement string in the previously spoken base input string. Once the matching portion of the previously spoken base input string is identified, the input correction logic module 212 is configured to automatically substitute the replacement string into the matching portion of the previously spoken base input string and process the modified spoken base input string as a new command or utterance. In the example embodiment, the input correction logic module 212 is configured to initially attempt to match the newly spoken replacement string to a most recently spoken base input string. If a match between the newly spoken replacement string and a portion of the most recently spoken base input string cannot be found, the input correction logic module 212 is configured to attempt to match the newly spoken replacement string to the previously spoken base input strings retained in the historical data set. In this manner, the user/speaker can utter a simple replacement string, which can be automatically applied to a current or historical base input string. A flowchart of this example embodiment is presented below in connection with FIG. 15.

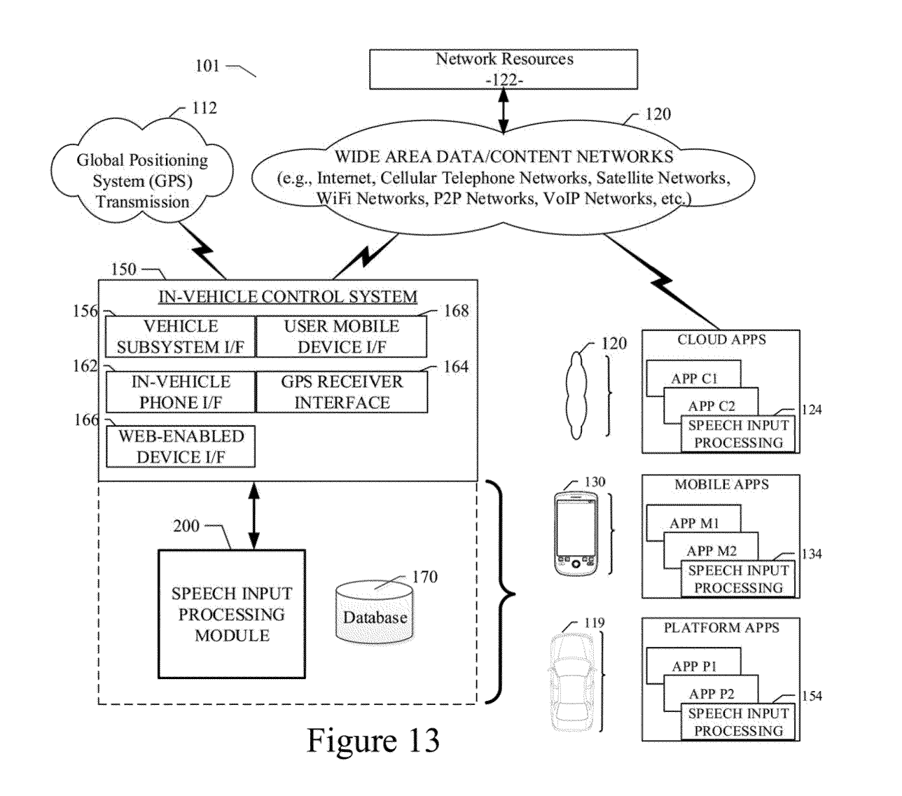

Referring now to FIG. 13, example embodiments are illustrated in which the processing of various embodiments is implemented by applications (apps) executing on any of a variety of platforms. As shown in FIG. 13, the processing performed by the speech input processing module 200 can be implemented in whole or in part by an app 154 executing on the in-vehicle control system 150 of vehicle 119, an app 134 executing on the mobile device 130, and/or an app 124 executing at a network resource 122 by a network service in the network cloud 120. The app 154 running on the in-vehicle control system 150 of vehicle 119 can be executed by a data processor of the in-vehicle control system 150. The results of this processing can be provided directly to subsystems of the in-vehicle control system 150. The app 134 running on the mobile device 130 can be executed by a data processor of the mobile device 130. The process for installing and executing an app on a mobile device 130 is well-known to those of ordinary skill in the art. The results of this processing can be provided to the mobile device 130 itself and/or the in-vehicle control system 150 via the mobile device interface. The app 124 running at a network resource 122 by a network service in the network cloud 120 can be executed by a data processor at the network resource 122. The process for installing and executing an app at a network resource 122 is also well-known to those of ordinary skill in the art. The results of this processing can be provided to the mobile device 130 and/or the in-vehicle control system 150 via the network 120 and the mobile device interface. As a result, the speech input processing module 200 can be implemented in any of a variety of ways using the resources available in the ecosystem 101.

Thus, as described herein in various example embodiments, the speech input processing module 200 can perform speech input correction in a variety of ways. As a result, the various embodiments allow the user/machine voice transaction to become more efficient, thereby increasing convenience, and reducing potential delays and frustration for the user by introducing predictive speech processing.

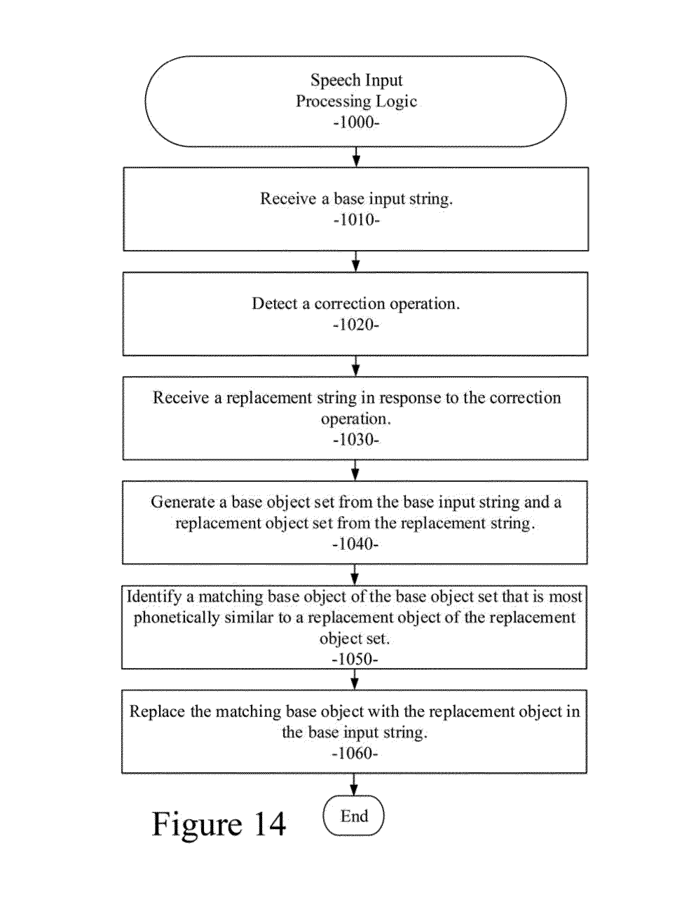

Referring now to FIG. 14, a flow diagram illustrates an example embodiment of a system and method 1000 for correcting speech input. The example embodiment can be configured to: receive a base input string (processing block 1010); detect a correction operation (processing block 1020); receive a replacement string in response to the correction operation (processing block 1030); generate a base object set from the base input string and a replacement object set from the replacement string (processing block 1040); identify a matching base object of the base object set that is most phonetically similar to a replacement object of the replacement object set (processing block 1050); and replace the matching base object with the replacement object in the base input string (processing block 1060).

Referring now to FIG. 15, a flow diagram illustrates an alternative example embodiment of a system and method 1100 for correcting speech input. The example embodiment can be configured to: receive a replacement string as part of a correction operation (processing block 1110); generate a replacement object set from the replacement string (processing block 1120); attempt to identify a matching base object of a current base object set that is most phonetically similar to a replacement object of the replacement object set (processing block 1130); identify the matching base object of a previous base object set, from a historical data set, that is most phonetically similar to the replacement object, if the matching base object cannot be found in the current base object set (processing block 1140); and replace the matching base object with the replacement object (processing block 1150).

As used herein and unless specified otherwise, the term “mobile device” includes any computing or communications device that can communicate with the in-vehicle control system 150 and/or the speech input processing module 200 described herein to obtain read or write access to data signals, messages, or content communicated via any mode of data communications. In many cases, the mobile device 130 is a handheld, portable device, such as a smart phone, mobile phone, cellular telephone, tablet computer, laptop computer, display pager, radio frequency (RF) device, infrared (IR) device, global positioning device (GPS), Personal Digital Assistants (PDA), handheld computers, wearable computer, portable game console, other mobile communication and/or computing device, or an integrated device combining one or more of the preceding devices, and the like. Additionally, the mobile device 130 can be a computing device, personal computer (PC), multiprocessor system, microprocessor-based or programmable consumer electronic device, network PC, diagnostics equipment, a system operated by a vehicle 119 manufacturer or service technician, and the like, and is not limited to portable devices. The mobile device 130 can receive and process data in any of a variety of data formats. The data format may include or be configured to operate with any programming format, protocol, or language including, but not limited to, JavaScript, C++, iOS, Android, etc.

As used herein and unless specified otherwise, the term “network resource” includes any device, system, or service that can communicate with the in-vehicle control system 150 and/or the speech input processing module 200 described herein to obtain read or write access to data signals, messages, or content communicated via any mode of inter-process or networked data communications. In many cases, the network resource 122 is a data network accessible computing platform, including client or server computers, websites, mobile devices, peer-to-peer (P2P) network nodes, and the like. Additionally, the network resource 122 can be a web appliance, a network router, switch, bridge, gateway, diagnostics equipment, a system operated by a vehicle 119 manufacturer or service technician, or any machine capable of executing a set of instructions (sequential or otherwise) that specify actions to be taken by that machine. Further, while only a single machine is illustrated, the term “machine” can also be taken to include any collection of machines that individually or jointly execute a set (or multiple sets) of instructions to perform any one or more of the methodologies discussed herein. The network resources 122 may include any of a variety of providers or processors of network transportable digital content. Typically, the file format that is employed is Extensible Markup Language (XML), however, the various embodiments are not so limited, and other file formats may be used. For example, data formats other than Hypertext Markup Language (HTML)/XML or formats other than open/standard data formats can be supported by various embodiments. Any electronic file format, such as Portable Document Format (PDF), audio (e.g., Motion Picture Experts Group Audio Layer 3—MP3, and the like), video (e.g., MP4, and the like), and any proprietary interchange format defined by specific content sites can be supported by the various embodiments described herein.

The wide area data network 120 (also denoted the network cloud) used with the network resources 122 can be configured to couple one computing or communication device with another computing or communication device. The network may be enabled to employ any form of computer readable data or media for communicating information from one electronic device to another. The network 120 can include the Internet in addition to other wide area networks (WANs), cellular telephone networks, metro-area networks, local area networks (LANs), other packet-switched networks, circuit-switched networks, direct data connections, such as through a universal serial bus (USB) or Ethernet port, other forms of computer-readable media, or any combination thereof. The network 120 can include the Internet in addition to other wide area networks (WANs), cellular telephone networks, satellite networks, over-the-air broadcast networks, AM/FM radio networks, pager networks, UHF networks, other broadcast networks, gaming networks, WiFi networks, peer-to-peer networks, Voice Over IP (VoIP) networks, metro-area networks, local area networks (LANs), other packet-switched networks, circuit-switched networks, direct data connections, such as through a universal serial bus (USB) or Ethernet port, other forms of computer-readable media, or any combination thereof. On an interconnected set of networks, including those based on differing architectures and protocols, a router or gateway can act as a link between networks, enabling messages to be sent between computing devices on different networks. Also, communication links within networks can typically include twisted wire pair cabling, USB, Firewire, Ethernet, or coaxial cable, while communication links between networks may utilize analog or digital telephone lines, full or fractional dedicated digital lines including T1, T2, T3, and T4, Integrated Services Digital Networks (ISDNs), Digital User Lines (DSLs), wireless links including satellite links, cellular telephone links, or other communication links known to those of ordinary skill in the art. Furthermore, remote computers and other related electronic devices can be remotely connected to the network via a modem and temporary telephone link.

The network 120 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. The network may also include an autonomous system of terminals, gateways, routers, and the like connected by wireless radio links or wireless transceivers. These connectors may be configured to move freely and randomly and organize themselves arbitrarily, such that the topology of the network may change rapidly. The network 120 may further employ one or more of a plurality of standard wireless and/or cellular protocols or access technologies including those set forth herein in connection with network interface 712 and network 714 described in the figures herewith.

In a particular embodiment, a mobile device 130 and/or a network resource 122 may act as a client device enabling a user to access and use the in-vehicle control system 150 and/or the speech input processing module 200 to interact with one or more components of a vehicle subsystem. These client devices 130 or 122 may include virtually any computing device that is configured to send and receive information over a network, such as network 120 as described herein. Such client devices may include mobile devices, such as cellular telephones, smart phones, tablet computers, display pagers, radio frequency (RF) devices, infrared (IR) devices, global positioning devices (GPS), Personal Digital Assistants (PDAs), handheld computers, wearable computers, game consoles, integrated devices combining one or more of the preceding devices, and the like. The client devices may also include other computing devices, such as personal computers (PCs), multiprocessor systems, microprocessor-based or programmable consumer electronics, network PC's, and the like. As such, client devices may range widely in terms of capabilities and features. For example, a client device configured as a cell phone may have a numeric keypad and a few lines of monochrome LCD display on which only text may be displayed. In another example, a web-enabled client device may have a touch sensitive screen, a stylus, and a color LCD display screen in which both text and graphics may be displayed. Moreover, the web-enabled client device may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScript, EXtensible HTML (xHTML), Compact HTML (CHTML), and the like, to display and send a message with relevant information.

The client devices may also include at least one client application that is configured to receive content or messages from another computing device via a network transmission. The client application may include a capability to provide and receive textual content, graphical content, video content, audio content, alerts, messages, notifications, and the like. Moreover, the client devices may be further configured to communicate and/or receive a message, such as through a Short Message Service (SMS), direct messaging (e.g., Twitter), email, Multimedia Message Service (MMS), instant messaging (IM), internet relay chat (IRC), mIRC, Jabber, Enhanced Messaging Service (EMS), text messaging, Smart Messaging, Over the Air (OTA) messaging, or the like, between another computing device, and the like. The client devices may also include a wireless application device on which a client application is configured to enable a user of the device to send and receive information to/from network resources wirelessly via the network.

The in-vehicle control system 150 and/or the speech input processing module 200 can be implemented using systems that enhance the security of the execution environment, thereby improving security and reducing the possibility that the in-vehicle control system 150 and/or the speech input processing module 200 and the related services could be compromised by viruses or malware. For example, the in-vehicle control system 150 and/or the speech input processing module 200 can be implemented using a Trusted Execution Environment, which can ensure that sensitive data is stored, processed, and communicated in a secure way.

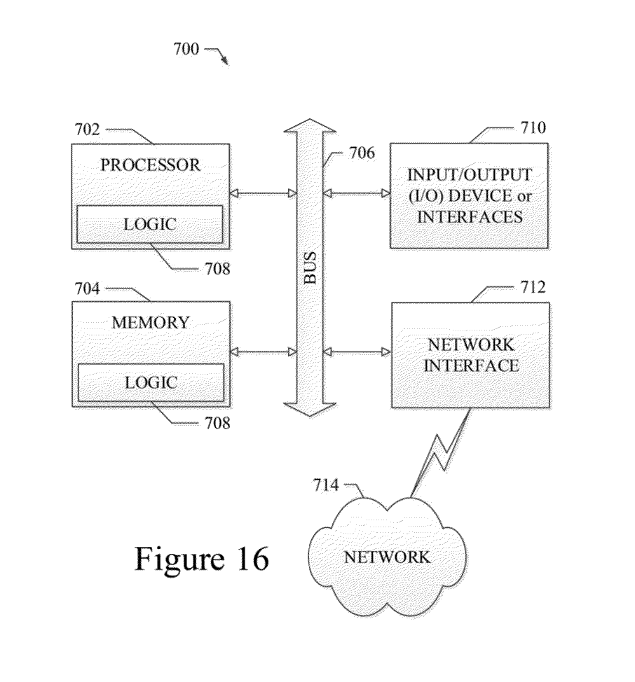

FIG. 16 shows a diagrammatic representation of a machine in the example form of a mobile computing and/or communication system 700 within which a set of instructions when executed and/or processing logic when activated may cause the machine to perform any one or more of the methodologies described and/or claimed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a laptop computer, a tablet computing system, a Personal Digital Assistant (PDA), a cellular telephone, a smartphone, a web appliance, a set-top box (STB), a network router, switch or bridge, or any machine capable of executing a set of instructions (sequential or otherwise) or activating processing logic that specify actions to be taken by that machine. Further, while only a single machine is illustrated, the term “machine” can also be taken to include any collection of machines that individually or jointly execute a set (or multiple sets) of instructions or processing logic to perform any one or more of the methodologies described and/or claimed herein.

The example mobile computing and/or communication system 700 can include a data processor 702 (e.g., a System-on-a-Chip (SoC), general processing core, graphics core, and optionally other processing logic) and a memory 704, which can communicate with each other via a bus or other data transfer system 706. The mobile computing and/or communication system 700 may further include various input/output (I/O) devices and/or interfaces 710, such as a touchscreen display, an audio jack, a voice interface, and optionally a network interface 712. In an example embodiment, the network interface 712 can include one or more radio transceivers configured for compatibility with any one or more standard wireless and/or cellular protocols or access technologies (e.g., 2nd (2G), 2.5, 3rd (3G), 4th (4G) generation, and future generation radio access for cellular systems, Global System for Mobile communication (GSM), General Packet Radio Services (GPRS), Enhanced Data GSM Environment (EDGE), Wideband Code Division Multiple Access (WCDMA), LTE, CDMA2000, WLAN, Wireless Router (WR) mesh, and the like). Network interface 712 may also be configured for use with various other wired and/or wireless communication protocols, including TCP/IP, UDP, SIP, SMS, RTP, WAP, CDMA, TDMA, UMTS, UWB, WiFi, WiMax, Bluetooth©, IEEE 802.11x, and the like. In essence, network interface 712 may include or support virtually any wired and/or wireless communication and data processing mechanisms by which information/data may travel between a mobile computing and/or communication system 700 and another computing or communication system via network 714.

The memory 704 can represent a machine-readable medium on which is stored one or more sets of instructions, software, firmware, or other processing logic (e.g., logic 708) embodying any one or more of the methodologies or functions described and/or claimed herein. The logic 708, or a portion thereof, may also reside, completely or at least partially within the processor 702 during execution thereof by the mobile computing and/or communication system 700. As such, the memory 704 and the processor 702 may also constitute machine-readable media. The logic 708, or a portion thereof, may also be configured as processing logic or logic, at least a portion of which is partially implemented in hardware. The logic 708, or a portion thereof, may further be transmitted or received over a network 714 via the network interface 712. While the machine-readable medium of an example embodiment can be a single medium, the term “machine-readable medium” should be taken to include a single non-transitory medium or multiple non-transitory media (e.g., a centralized or distributed database, and/or associated caches and computing systems) that store the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A system comprising:
a data processor; and
a speech input processing module, executable by the data processor, the speech input processing module being configured to:
receive a base input string;
detect a correction operation;
receive a replacement string in response to the correction operation;
generate a base object set from the base input string and a replacement object set from the replacement string;
identify a matching base object of the base object set that is most phonetically similar to a replacement object of the replacement object set; and
replace the matching base object with the replacement object in the base input string.

2. The system of claim 1 wherein the base input string is received as a spoken utterance.

3. The system of claim 1 wherein the correction operation is explicitly initiated by use of an input mechanism from the group consisting of: clicking an icon, activating a softkey, pressing a physical button, providing a keyboard input, manipulating a user interface, and uttering a separate audible command.

4. The system of claim 1 wherein the correction operation is implicitly initiated by detection of a speaker audibly spelling out a word or phrase.

5. The system of claim 1 wherein the replacement is received as a spoken utterance.

6. The system of claim 1 being further configured to generate a phonetic representation of each of a plurality of objects in the base object set.

7. The system of claim 1 being further configured to generate a phonetic representation of each of a plurality of objects in the replacement object set.

8. The system of claim 1 being further configured to generate a difference score between each of a plurality of objects in the base object set and each of a plurality of objects in the replacement object set.

9. The system of claim 1 wherein the speech input processing module is included in an application (app) executed on a platform from the group consisting of: a mobile device, an in-vehicle control system, and a network service in a network cloud.

10. A method comprising:
receiving a base input string;
detecting a correction operation;
receiving a replacement string in response to the correction operation;
generating a base object set from the base input string and a replacement object set from the replacement string;
identifying a matching base object of the base object set that is most phonetically similar to a replacement object of the replacement object set; and
replacing the matching base object with the replacement object in the base input string.

11. The method of claim 10 wherein the base input string is received as a spoken utterance.

12. The method of claim 10 wherein the correction operation is explicitly initiated by use of an input mechanism from the group consisting of: clicking an icon, activating a softkey, pressing a physical button, providing a keyboard input, manipulating a user interface, and uttering a separate audible command.

13. The method of claim 10 wherein the correction operation is implicitly initiated by detection of a speaker audibly spelling out a word or phrase.

14. The method of claim 10 wherein the replacement string is received as a spoken utterance.

15. The method of claim 10 including generating a phonetic representation of each of a plurality of objects in the base object set.

16. The method of claim 10 including generating a phonetic representation of each of a plurality of objects in the replacement object set.

17. The method of claim 10 including generating a difference score between each of a plurality of objects in the base object set and each of a plurality of objects in the replacement object set.

18. The method of claim 10 wherein the method is performed by an application (app) executed on a platform from the group consisting of: a mobile device, an in-vehicle control system, and a network service in a network cloud.

19. A non-transitory machine-useable storage medium embodying instructions which, when executed by a machine, cause the machine to:
receive a base input string;
detect a correction operation;
receive a replacement string in response to the correction operation;
generate a base object set from the base input string and a replacement object set from the replacement string;
identify a matching base object of the base object set that is most phonetically similar to a replacement object of the replacement object set; and
replace the matching base object with the replacement object in the base input string.

20. The machine-useable storage medium as claimed in claim 19 wherein the instructions are included in an application (app) executed on a platform from the group consisting of: a mobile device, an in-vehicle control system, and a network service in a network cloud.
